(19) United States
(12) Patent Application Publication
(10) Pub. No.: US 2008/0066266 A1
(43) Pub. Date: Mar. 20, 2008

(54) Fastener assembly

(76) Inventors: Derek Scroggie, Macomb, MI (US); Robert Osterland, East China, MI (US); Brett J. Jurily, Grosse Point Farms, MI (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/891,700

(22) Filed: Aug. 13, 2007

Related U.S. Application Data
(60) Provisional application No. 60/844,620, filed on Sep. 14, 2006.

(51) Int. Cl. B62D 65/14

(52) U.S. Cl. 24/297; 24/458; 296/1.08; 411/48

(57) ABSTRACT

A fastener assembly configured to secure a first panel with respect to a second panel includes a base having lateral wings connected to a central post. The lateral wings and the central post converge at a distal tip. Each of the lateral wings includes a first outer surface and a second outer surface, wherein the first outer surface is inwardly angled toward the distal tip. The fastener assembly also includes angled retaining ledges located between the first outer surface and the second outer surface. The angled retaining ledges are canted in a non-parallel fashion with respect to a plane of at least one of the first and second panels. The angled retaining ledges allow for safe and easy removal of the base from at least one of the first and second panels.

### RELATED APPLICATIONS

This application relates to and claims priority benefits from U.S. Provisional Patent Application No. 60/844,620 entitled “Fastener Assembly,” filed Sep. 14, 2006, which is hereby incorporated by reference in its entirety.

### FIELD OF THE INVENTION

Embodiments of the present invention generally relate to a fastener configured to connect first and second components together, and more particularly to a fastener configured to connect panels of an automobile assembly to panel molding and trim pieces.

### BACKGROUND OF THE INVENTION

Various assemblies include panels or objects connected to one another. Automobile assemblies, for example, include various panels and structures connected to other panels or structures, or to the automobile frame itself. In particular, snap-fit assemblies may be used to connect the pieces together. Additionally, a fastener may be preassembled with one of the components or panels, while the second component or panel is connected to the preassembly during final assembly. A plurality of the fasteners may be used when connecting relatively large components together. Fasteners of this general type have been provided in a variety of shapes and configurations suitable for the particular components to be connected.

One type of fastener used to connect components together is a symmetrical connector having a base with a W-shape. These types of fasteners provide quick and easy assembly. Additionally, the W-shape fastener securely retains moldings of structural panels, while also being relatively easy to remove.

FIG. 1 illustrates a front view of a known W-shape fastener assembly 10 securing a first panel 12 to a second panel 14. The first panel 12 may be a molding flange, while the second panel 14 may be a mating panel within an automobile frame or body. The fastener assembly 10 includes a W-shaped base 16 integrally connected to a planar collar 18. The collar 18 is connected to a cylindrical neck 20, which is, in turn, connected to a planar head 22. Typically, the collar 18 and the head 22 are parallel to one another and separated from one another by the neck 20.

The W-shaped base 16 includes two lateral wings 24 having distal ends (or nose portions) 26 integrally connected to a distal end 28 of a central post 30 that extends downwardly from the collar 18. The lateral wings 24 angle away from the central post 30. The lateral wings 24 include inwardly-angled flat or straight lower outer surfaces 32 integrally connected to outwardly-angled flat or straight upper outer surfaces 34. As shown in FIG. 1, the lower outer surfaces 32 are inwardly angled toward the distal ends 26 when moving from top to bottom. Further, the upper outer surfaces 34 are outwardly angled toward the lower outer surfaces 32 when moving from top to bottom.

A retaining ledge 36 is located proximate the union of each lower outer surface 32 and each upper outer surface 34. The retaining ledge 36 ensures that the second panel 14 remains attached to the fastener assembly 10, as discussed below.

As shown in FIG. 1, the distal tip 35 of the W-shaped base 16, i.e., where the wings 24 and central post 30 join, includes a central gap or slot 37. The central gap 37 allows the wings 24 to flex toward the central post 30 when the base 16 is being inserted into a hole 33 formed through the second panel 14.

FIG. 2 illustrates a top isometric view of the known first panel 12, such as a molding flange. The first panel 12 includes a central hole 38 connected to a passage 40. Thus, an open end is formed in the first panel 12. Referring to FIGS. 1 and 2, in order to secure the fastener assembly 10 to the first panel, the neck 20 is aligned with the passage 40 and is inwardly urged in the direction of arrow A. As the neck 20 moves into the first panel 12, arms 42 on either side of the passage 40 outwardly flex. When the neck 20 moves into the central hole 38, the arms 42 inwardly snap back, thereby securing the neck 20 within the first panel 12. Thus, the fastener assembly 10 is secured to the first panel 12.

FIG. 3 illustrates an isometric top view of the second panel 14. The second panel 14 includes the hole 33 or slot. Referring to FIGS. 1 and 3, and as discussed above, in order to secure the fastener assembly 10 to the second panel 14, the W-shaped base 16 is urged into the hole 33 or slot in the direction of arrow B. As the W-shaped base 16 moves into the hole 3 or slot 3, the lower outer surfaces 32 slide over edges that define the hole 33. The lateral wings 24 inwardly flex as the base 16 continues its progression into the hole 33. As noted above, the central gap 37 formed in the distal tip 35 allows for easier flexing of the lateral wings 24. With continued progress, the hole 33 or slot snaps over the retaining ledges 36, and continues to move over the upper outer surfaces 34. With continued progress over the upper outer surfaces 34, the lateral wings 24 flex back to their at-rest positions.

The retaining ledges 36 ensure that the base 16 does not dislodge from the second panel 14. As shown in FIG. 1, the retaining ledges 36 are generally parallel with the second panel 14. Thus, if the fastener assembly 10 is urged upwardly in the direction of arrow B′ with respect to the second panel 14, the flat retaining ledges 36 abut the flat second panel 14, thereby preventing the base 16 from dislodging from the second panel 14.

For various reasons, however, the fastener assembly 10 may need to be removed from the second panel 14. For example, the fastener assembly 10 may be removed from the second panel 14 if the panels 12 and 14 are misaligned, the panels 12 and 14 are defective, or maintenance is necessary. A high removal force is typically required to remove the fastener assembly 10 from the second panel 14 due to the retaining ledges 36 abutting the second panel 14 when the fastener assembly 10 is moved in the direction of arrow B′ with respect to the second panel 14. In various situations, when the fastener assembly 10 is removed from the second panel 14, the retaining ledges 36 snag and damage the second panel 14, or vice versa, as the fastener assembly 10 is removed from the second panel 14. That is, when the retaining ledges 36 snag or latch onto the second panel 14, a user needs to apply even more force to remove the fastener assembly 10. The increased force, however, may snap the retaining ledges 36 and/or fray, perforate, or otherwise damage the second panel 14.

### SUMMARY OF THE INVENTION

Embodiments of the present invention provide a low profile fastener that may be used in tight spaces, e.g., where packing conditions are limited, that is easy to manipulate and use, and maintains a proper fit and retaining strength with respect to secured components. Further, embodiments of the present invention provide a fastener that allows the connected components to be relatively easy to remove when desired.

Certain embodiments of the present invention provide a fastener assembly configured to secure a first panel with respect to a second panel. The fastener assembly may include a base that includes lateral wings connected to a central post. The lateral wings and the central post converge at a distal tip. Each of the lateral wings includes a first outer surface, such as a lower outer surface, and a second outer surface, such as an upper outer surface, wherein the first outer surface is inwardly angled toward the distal tip (from a first portion, such as a top portion, to a second portion, such as a bottom portion). The second outer surface may be oppositely angled.

The fastener assembly also includes angled retaining ledges located between the first outer surface and the second outer surface. Optionally, the angled retaining ledges may be located at other positions. For example, the angled retaining ledges may be located on either of the first and second outer surfaces. The angled retaining ledges are vertically canted in a non-parallel fashion with respect to a plane of at least one of the first and second panels to provide safety angles. The angled retaining ledges allow for safe and easy removal of the base from at least one of the first and second panels. At the same time, the angled retaining ledges ensure that the fastener assembly does not dislodge from the first or second panel when a force less than the removal force is applied or exerted on the fastener assembly and/or the panels.

The angled retaining ledges prevent the base from dislodging from at least one of the first and/or second panels when less than a removal force is applied. Further, the angled retaining ledges allow the base to be removed from at least one of the first and/or second panels when the removal force is applied.

The fastener assembly may also include a planar collar connected to the central post, and a planar head connected to the planar collar through a neck. One of the first and second panels is configured to be secured between the planar collar and the planar head, and the other of the first and second panels is configured to be secured about the base. The planar collar and the planar head may be parallel with one another. The angled retaining ledges may be canted in a non-parallel fashion with respect to the planar collar and the planar head. The planar head may include at least one notch configured to securely mate with a reciprocal structure on one of the first and second panels.

The second outer surface may be rounded with respect to a longitudinal direction of the second outer surface. That is, the entire length of the second outer surface may be rounded.

The second outer surface may also be rounded with respect to lateral directions of the second outer surface over a length of the second outer surface. That is, lateral portions of the second outer surface may be rounded or curved over an entire radius of the curved second outer surface, thereby preventing any sharp or straight edges. In general, the second outer surface may be completely rounded in all directions.

### BRIEF DESCRIPTION OF SEVERAL VIEWS OF THE DRAWINGS

FIG. 1 illustrates a front view of a known W-shape fastener assembly securing a first panel to a second panel.

FIG. 2 illustrates a top isometric view of a known first panel.

FIG. 3 illustrates an isometric top view of a known second panel.

FIG. 4 illustrates an isometric view of a fastener assembly according to an embodiment of the present invention.

FIG. 5 illustrates a front view of a fastener assembly according to an embodiment of the present invention.

FIG. 6 illustrates a front view of a fastener assembly securing a first panel to a second panel according to an embodiment of the present invention.

FIG. 7 illustrates an isometric view of a fastener assembly according to an embodiment of the present invention.

FIG. 8 illustrates a top plan view of a fastener assembly according to an embodiment of the present invention.

FIG. 9 illustrates a cross-sectional view of a fastener assembly through line 9-9 of FIG. 8 according to an embodiment of the present invention.

FIG. 10 illustrates a front view of a fastener assembly securing a first panel to a second panel according to an embodiment of the present invention.

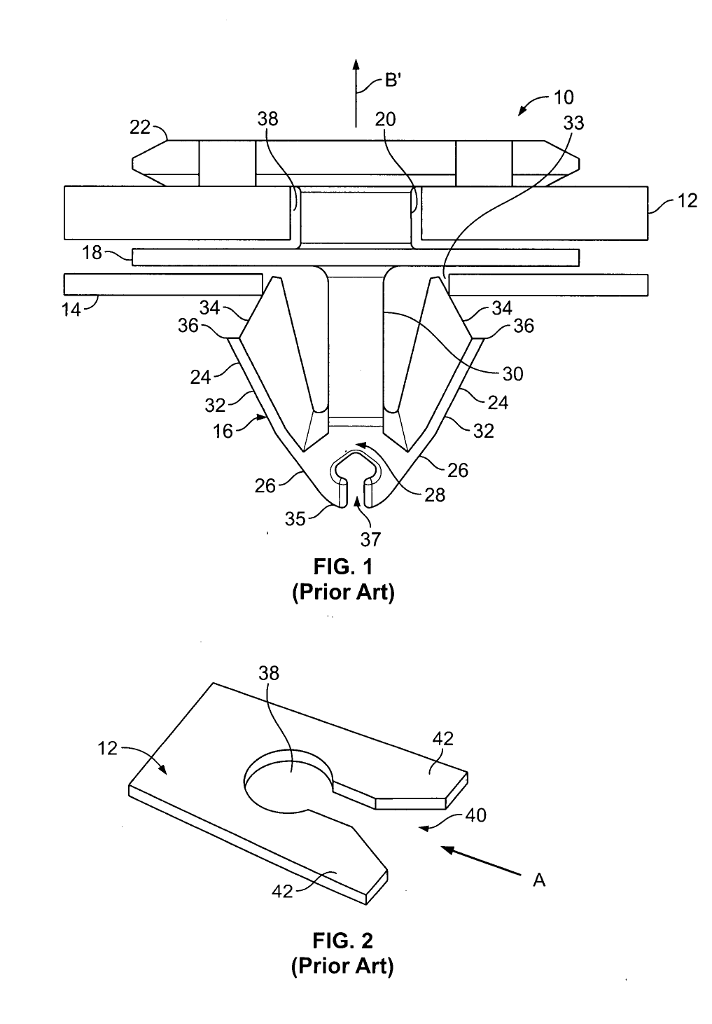

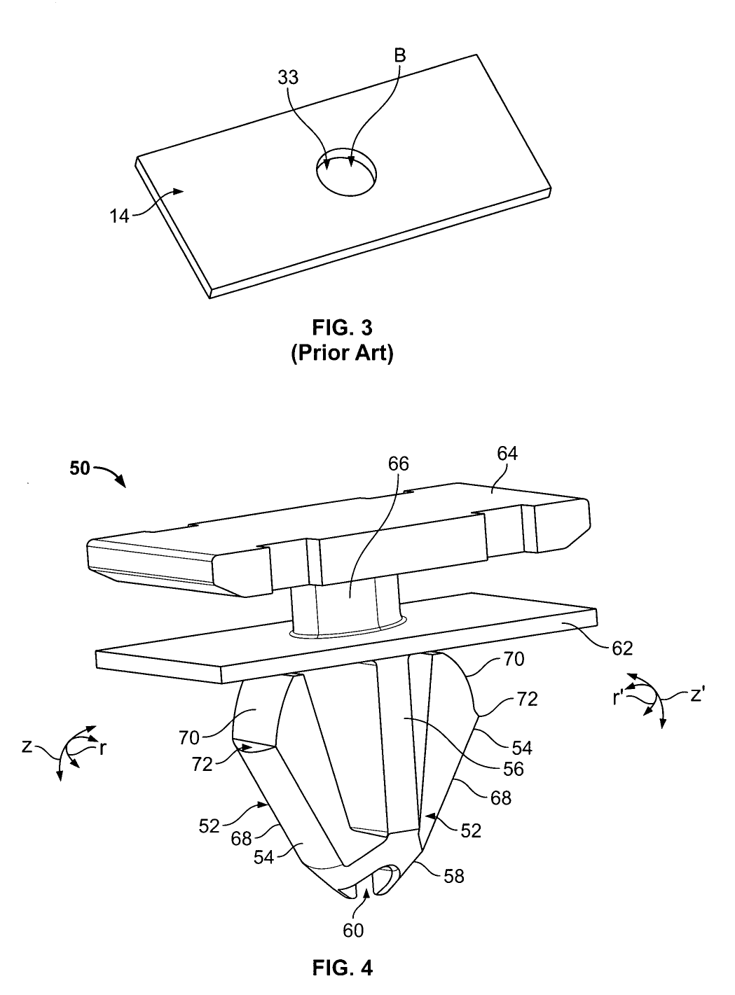

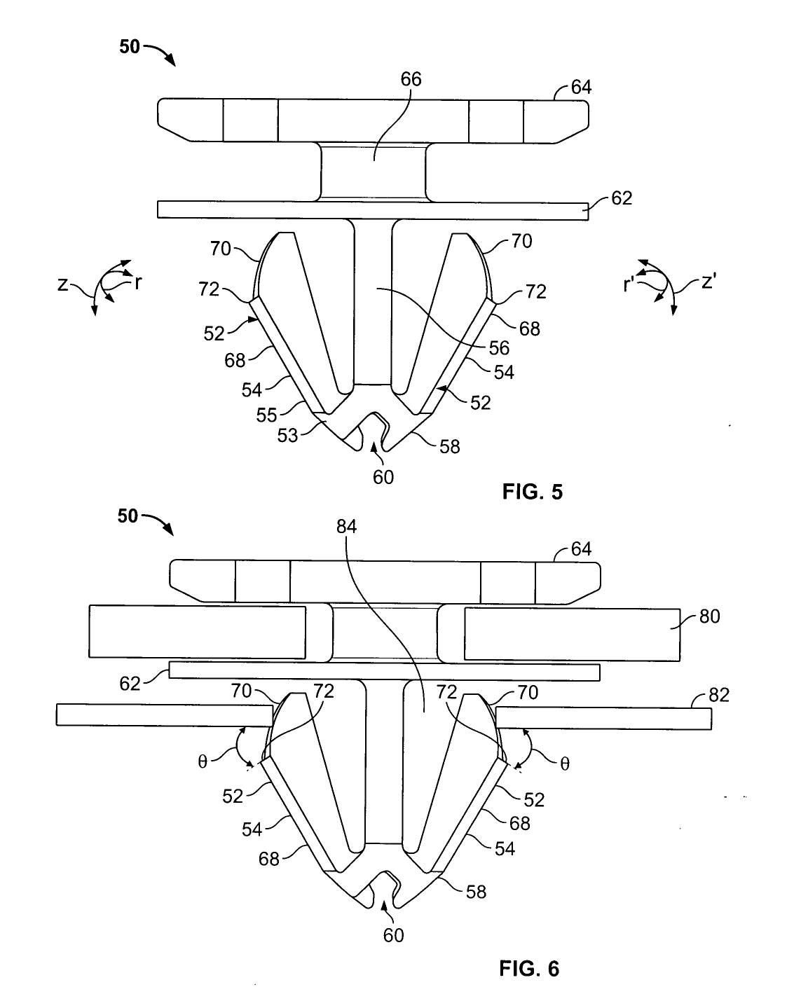

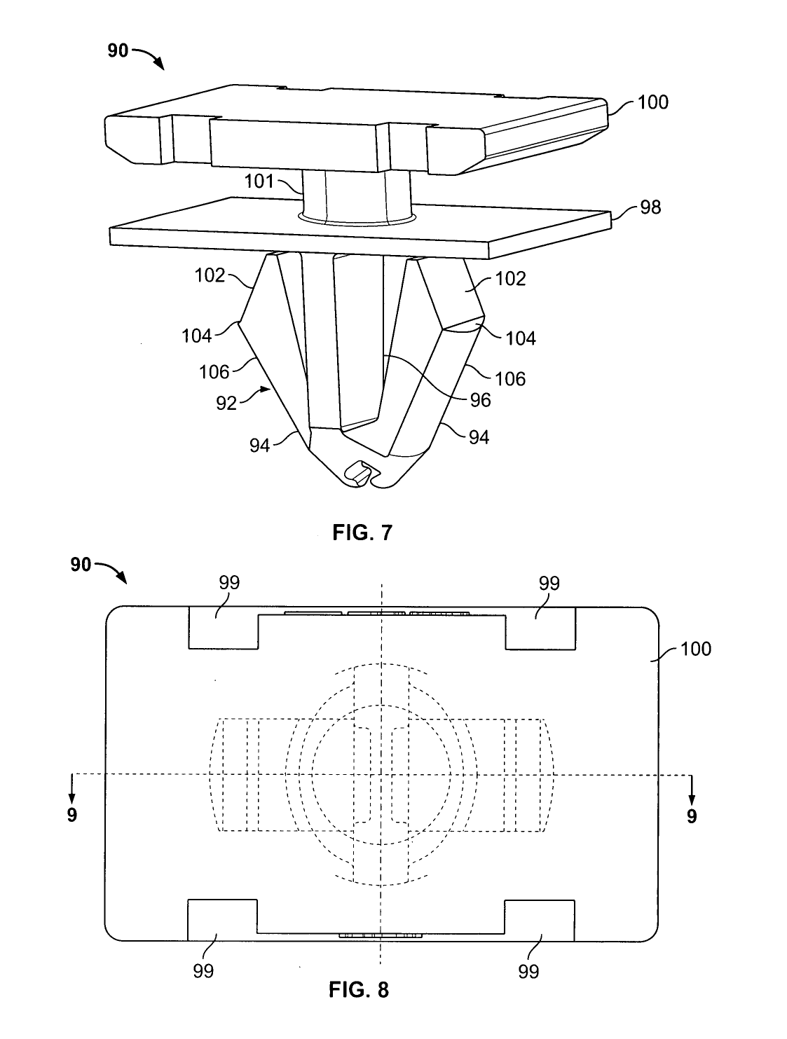

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE INVENTION

FIG. 4 illustrates an isometric view of a fastener assembly 50 according to an embodiment of the present invention. FIG. 5 illustrates a front view of the fastener assembly 50. The fastener assembly 50 may be integrally formed and manufactured as a single piece. Further, the fastener assembly 50 may be formed of various materials such as rubber, plastic, or metal. The fastener assembly 50 may also include a foam seal (not shown).

Referring to FIGS. 4 and 5, the fastener assembly 50 includes similar components as the fastener assembly 10. In particular, the fastener assembly 50 includes a W-shaped base 52 having resilient lateral wings 54 connected to a central post 56 through a distal tip 58 having a central gap 60. The central post 56, the lateral wings 54, and two-stage enter angle of the distal tip 58 assist an operator in finding a location of a hole in a mating panel. That is, the sloped surfaces 53 and 55 of the distal tip 58 allow the fastener assembly 50 to slidably engage a hole. For example, the sloped surfaces 53 and 55 allow the distal tip 58 to slide over edges that define a hole until the distal tip 58 is positioned over the hole, at which point the distal tip passes into the hole.

The central gap 60, or interposing keyhole slot, cooperates with the flexible, resilient lateral wings 54 to provide easier insertion and extraction with respect to a hole of a mating panel. The lateral wings 54 may flex with respect to one another because the central gap 60 is positioned between distal ends of the lateral wings 54. Thus, during insertion and extraction, the lateral wings 54 may flex with respect to one another, thereby decreasing the cross-sectional area of the W-shaped base 52.

The central post 56 is connected to a planar collar 62, which is in turn connected to a planar head 64 through a neck 66. As discussed above, a first panel, such as a molding flange, is configured to be secured around the neck 66 between the collar 62 and the head 64. Further, the base 52 is configured to be secured within a hole of a second panel, such as within an automobile.

Unlike the fastener assembly 10, however, the base 52 includes features that allow it to securely retain the second panel, while allowing the fastener assembly 10 to be easily removed, when desired, without damaging the second panel and/or the fastener assembly 10. As shown in FIG. 4, the lateral wings 54 include inwardly-angled (from the top to the distal tip 58) lower outer surfaces 68 and outwardly-angled (from top to bottom) upper outer surfaces 70. The lower outer surfaces 68 may be rounded, flat or straight. The upper outer surfaces 70 may be curved or rounded. The upper outer surfaces 70 may be vertically curved in the directions of arrows Z and Z′. Additionally, the upper outer surfaces 70 may be radially curved in the directions of arrows r and r′ over the curve of the upper outer surfaces 70. As such, the upper outer surfaces 70 may not include any sharp or linear edges. Instead, the entirety of the upper outer surfaces 70 may be rounded. Because the upper outer surfaces 70 are rounded, they are not susceptible to snagging the second panel during removal. Thus, the rounded upper outer surfaces 70 safely move through a hole formed in the second panel when a suitable removal force is exerted.

At the same time, the rounded upper outer surfaces 70 are configured to exert an outwardly-directed retaining force into the second panel when no removal force is exerted. Thus, the fastener assembly 50 is able to securely retain the second panel under normal conditions, when a removal force is not exerted or applied. When a suitable removal force is exerted, however, the rounded upper outer surfaces 70 safely move through the hole, thereby allowing the lateral wings 54 to inwardly flex. The fastener assembly 50 may be manufactured having a stiffness and resiliency that is adapted to a particular application. If a certain amount of force is needed to ensure that the fastener assembly 50 securely retains the second panel while allowing the fastener assembly 50 to be removed using a particular increased amount of force, suitable design and dimensional specifications, materials and manufacturing processes may be used to form the fastener assembly 50 according to those specifications.

Certain embodiments of the present invention, such as the fastener assembly 50, rounded upper outer surfaces 70 having vertical radiuses that are applied to the holding angles on the lateral wings 54. The radial radiuses on the lateral wings 54 provide proper retention load of the assembled system (retainer, molding and mating panel), while meeting serviceability removal efforts.

In addition to the rounded upper outer surfaces 70, the fastener assembly 50 includes retaining ledges 72 between the rounded upper outer surfaces 70 and the lower outer surfaces 68. Unlike the retaining ledges 36 of the fastener assembly 10, however, the retaining ledges 72 are angled with respect to the plane of the collar 62. Thus, the retaining ledges 72 are angled with respect the plane of the second panel.

The retaining ledges 72 are downwardly-angled in that they are canted down from the rounded upper outer surfaces 70 toward the lower outer surfaces 68. The downwardly-angled nature of the retaining ledges 72 ensures that the fastener assembly 50 does not dislodge from the second panel, while allowing the fastener assembly 50 to be safely removed when desired.

FIG. 6 illustrates a front view of the fastener assembly 50 securing a first panel 80 to a second panel 82 according to an embodiment of the present invention. As shown in FIG. 6, the first panel 80 is secured between the collar 62 and the head 64, while the second panel 82 is secured to the base 52. The rounded upper outer surfaces 70 exert outwardly directed forces into edges of the second panel that define a hole 84. The outwardly directed forces ensure that the base 52 is snugly secured within the hole 84.

As shown in FIG. 6, the planes of the retaining ledges 72 are angled with respect to the plane of the second panel 82 at angle θ. Angle θ is a safety angle that results from the retaining ledges 72 being downwardly angled or canted from the bottom portions of the rounded upper outer portions 70 toward the upper portions of the lower outer portions 68. Thus, the retaining ledges 72 are not parallel to the plane of the second panel 82, whether the lateral wings 54 are at rest, or being squeezed toward one another.

Angle θ may vary depending on a particular application. For example, if a particularly strong, robust hold is desired, the angle θ may be relatively small (e.g., between 5° and 20°). If, however, the application is less susceptible to dislodging, and an easy removal force is desired, then the angle θ may be larger (e.g., between 20° and 45°). Angle θ may vary depending on the application, and the above dimensions are but mere examples.

During normal operation, the retaining ledges 72 ensure that the fastener assembly 50 does not dislodge from the second panel 82. If the fastener assembly 50 upwardly shifts with respect to the second panel 82, the retaining ledges 72 abut the second panel 82 thereby ensuring that the fastener assembly 50 does not dislodge.

During removal, an operator manipulates the head 64 and pulls upward with respect to the second panel 82. The fastener assembly 50 is configured to allow the fastener assembly 50 to be removed from the second panel 82 when a predetermined amount of removal force is applied. As the fastener assembly 50 moves upward, the rounded upper outer surfaces 70 slide past the edges that define the hole 84. Because the upper outer surfaces 70 are rounded, they do not snag or otherwise damage the second panel 82, and vice versa.

When the second panel 82 encounters the retaining ledges 72, the downwardly angled nature of the retaining ledges 72 allow them to enter the hole 84. If a force less than the removal force is exerted, the retaining ledges 72 do not enter the hole 84. As such, the fastener assembly 50 is prevented from dislodging from the second panel 82. When a force equal or greater to the removal force is applied, however, the downwardly angled retaining ledges 72 enter into the hole 84 due to the fact that they do not lockingly engage the second panel 82 (as is the case if the retaining ledges 72 and the second panel 82 were parallel). As the retaining ledges 72 enter the hole, the lateral wings 54 inwardly flex as they proceed further into the hole 84. The flexing of the lateral wings 54 is made easier due to the central gap or slot 60 formed in the distal tip 58.

The retaining ledges 72 slide through the hole 84 as the removal force is continually applied, thereby allowing the fastener assembly 50 to be removed from the second panel 82. Because the retaining ledges 72 are downwardly angled, the retaining ledges 72 do not snag or latch onto the second panel 82, unlike the fastener assembly 10.

During removal, the planes of the retaining ledges 72 are not parallel to the plane of the second panel 82, which is in stark contrast to the known fastener assembly 10. As such, the retaining ledges 72 are not susceptible to snagging, gouging, fraying, or otherwise damaging the second panel 82, nor are the retaining ledges 72 susceptible to being damaged during removal.

The angles between the retaining ledges, or safety hooks, 72 and the second panel 82 (and the collar 62) are safety angles that allow removal of the fastener assembly 50 from the mating hole 84 of the second panel 82 with minimal damage to the hole 84 and the panel 82, while providing a safety hook type feature that ensures that the fastener assembly 50 does not dislodge from the panel 82 during normal operation.

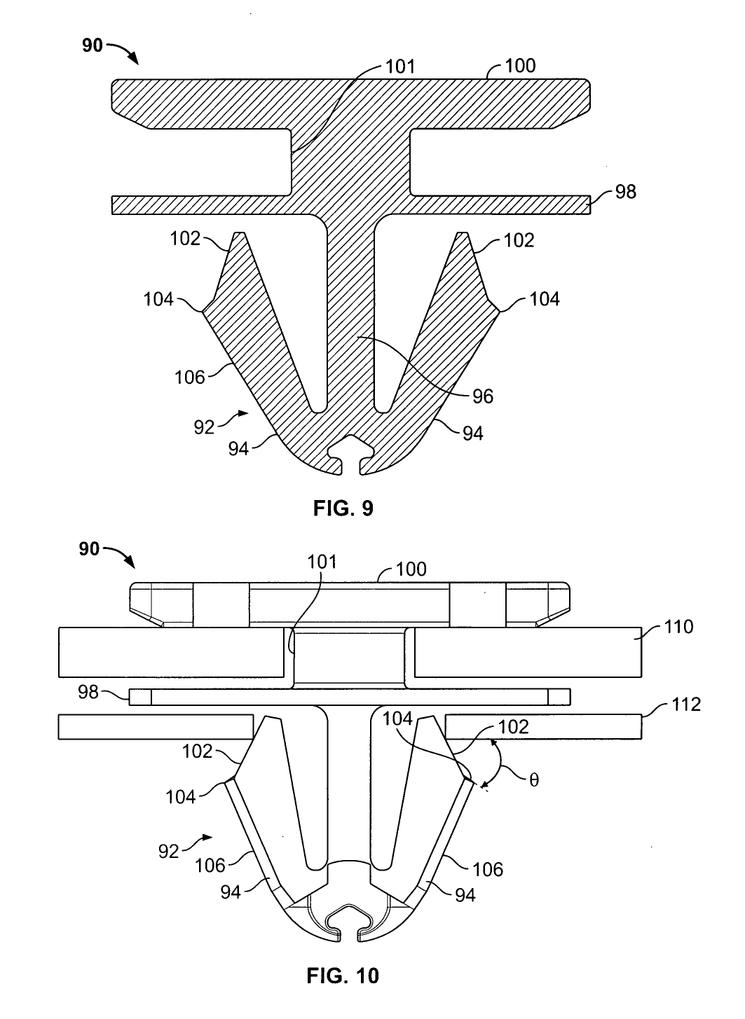

FIG. 7 illustrates an isometric view of a fastener assembly 90 according to an embodiment of the present invention. FIG. 8 illustrates a top plan view of the fastener assembly 90, while FIG. 9 illustrates a cross-sectional view of the fastener assembly through line 9-9 of FIG. 8. Referring to FIGS. 7-9, the fastener assembly 90 includes a W-shaped base 92 having lateral wings 94 connected to a central post 96, as discussed above. The central post 96 is connected to a collar 98, which, in turn, connects to a head 100 through a neck 101, as also discussed above. The fastener assembly 90 is similar to the fastener assembly 50, except that the fastener assembly 90 does not include curved or rounded upper outer surfaces. Instead, the lateral wings 94 of the fastener assembly 90 include straight or flat upper outer surfaces 102. Downwardly angled retaining ledges 104 are located between bottom portions of the upper outer surface 102 and upper portions of the lower outer surfaces 106.

As shown in FIG. 8, notches 99 are formed in the head 100 of the fastener assembly 90. The notches 99 are configured to maintain the fastener assembly 90 in a fixed position with respect to a panel, such as a molding panel, during shipment and initial assembly. For example, the molding flange may include reciprocal tabs, bumps, or other protuberances that are mated into the notches 99 during shipment and initial assembly.

FIG. 10 illustrates a front view of the fastener assembly 90 securing a first panel 110 to a second panel 112 according to an embodiment of the present invention. The retaining ledges 104 are configured and operate similar to the retaining ledges 72 shown and described in FIGS. 4-6. It has been found that because the upper outer surfaces 102 are flat, the force required for removal from the second panel 112 may be higher as compared to the fastener assembly 50. The rounded surfaces of the upper outer surfaces 70 of the fastener assembly 50 (shown in FIGS. 4-6) move through a hole of a panel easier than the flat upper outer surfaces 102. Thus, the upper outer surfaces 102 of the fastener assembly 90 provide a more robust hold than the rounded upper outer surfaces 70 of the fastener assembly 50.

Thus, embodiments of the present invention provide a low profile fastener assembly that may be used in tight spaces. Embodiments of the present invention maintain a proper fit and retaining strength with respect to secured components. Further, embodiments of the present invention provide a fastener assembly that allows the connected components to be relatively easy to remove when desired. When the fastener assembly is removed, the fastener assembly itself and the previously secured components are not susceptible to being damaged.

The angled retaining ledges and rounded upper outer surfaces of the embodiments of the present invention prevent damage to the mating structure, e.g., a mating panel, when the fastener assembly is removed. The angled retaining ledges in particular provide a safety angle with respect to a plane of a mating structure. Unlike known fastener assemblies, embodiments of the present invention allow for safe and easy removal of a fastener assembly from a mating component.

Embodiments of the present invention provide low profile serviceable W-shaped base fastening assemblies or retaining fasteners for securing moldings to sheet metal panels where packing conditions are limited, while allowing for acceptable removal efforts to meet serviceability requirements. The fastening assemblies may be used with various components, such as automotive body side moldings including doors, rockers, wheel flares, A-pillars and other areas.

It is to be understood that terms such as top, bottom, above, below, lower, and upper are relative terms. While these terms have been used to describe embodiments of the invention, such terms are merely used with respect to the drawings. That is, the orientations described may be inverted depending on the placement of the embodiments shown and described.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A fastener assembly configured to secure a first panel with respect to a second panel, the fastener assembly comprising:
a base comprising lateral wings connected to a central post, said lateral wings and said central post converging at a distal tip, each of said lateral wings comprising a first outer surface and a second outer surface, wherein said first outer surface is inwardly angled toward said distal tip; and
angled retaining ledges that are canted in a non-parallel fashion with respect to a plane of at least one of the first and second panels, said angled retaining ledges allowing for safe and easy removal of said base from at least one of the first and second panels.

2. The fastener assembly of claim 1, further comprising:
a planar collar connected to said central post; and
a planar head connected to said planar collar through a neck,
wherein one of the first and second panels is configured to be secured between said planar collar and said planar head, and wherein the other of the first and second panels is configured to be secured about said base.

3. The fastener assembly of claim 2, wherein said planar collar and said planar head are parallel with one another, and wherein said angled retaining ledges are canted in a non-parallel fashion with respect to said planar collar and said planar head.

4. The fastener assembly of claim 2, wherein said planar head comprises at least one notch configured to securely mate with a reciprocal structure on one of the first and second panels.

5. The fastener assembly of claim 1, wherein said second outer surface is rounded with respect to a longitudinal direction of said second outer surface.

6. The fastener assembly of claim 1, wherein said second outer surface is rounded with respect to lateral directions of said second outer surface over a length of said second outer surface.

7. The fastener assembly of claim 1, wherein said second outer surface is completely rounded.

8. The fastener assembly of claim 1, wherein said distal tip comprises a central gap that provides increased flexibility to said lateral wings.

9. The fastener assembly of claim 1, wherein said angled retaining ledges prevent said base from dislodging from at least one of the first and second panels when less than a removal force is applied, and wherein said angled retaining ledges allow said base to be removed from at least one of the first and second panels when the removal force is applied.

10. A system comprising:
a first panel;
a second panel; and
a fastening assembly that secures said first panel with respect to said second panel, said fastener assembly comprising:
a W-shaped base comprising first and second lateral wings connected to a central post, said first and second lateral wings and said central post converging at a distal tip, each of said first and second lateral wings comprising a first outer surface and a second outer surface, wherein said first outer surface is inwardly angled toward said distal tip;
a planar collar connected to said central post;
a planar head connected to said planar collar through a neck, said first panel being configured to be secured between said planar collar and said planar head, and said second panel being configured to be secured about said base; and
angled retaining ledges located between said first outer surfaces and said second outer surfaces, said angled retaining ledges being canted in a non-parallel fashion with respect to a plane of at least one of said first and second panels, said angled retaining ledges allowing for safe and easy removal of said base from at least one of the first and second panels.

11. The system of claim 10, wherein said planar collar and said planar head are parallel with one another, and wherein said angled retaining ledges are canted in a non-parallel fashion with respect to said planar collar and said planar head

12. The system of claim 10, wherein said planar head comprises at least one notch, and said first panel comprises at least one reciprocal structure, said at least one notch configured to securely mate with said reciprocal structure during shipment.

13. The system of claim 10, wherein said second outer surface is rounded with respect to a longitudinal direction of said second outer surface.

14. The system of claim 10, wherein said second outer surface is rounded with respect to lateral directions of said second outer surface over a length of said second outer surface.

15. The system of claim 10, wherein said second outer surface is completely rounded.

16. The system of claim 10, wherein said distal tip comprises an interposing keyhole slot that provides increased flexibility to said lateral wings.

17. The system of claim 10, wherein said angled retaining ledges prevent said base from dislodging from said first panel when less than a removal force is applied to said base with respect to said first panel, and wherein said angled retaining ledges allow said base to be removed from said first panel when the removal force is applied to said base with respect to said first panel.

18. A fastener assembly configured to secure a first panel with respect to a second panel, the fastener assembly comprising:
a base comprising lateral wings connected to a central post, said lateral wings and said central post converging at a distal tip, each of said lateral wings comprising a first outer surface and a second outer surface, wherein said first outer surface is inwardly angled toward said distal tip;
a planar collar connected to said central post; and
a planar head connected to said planar collar through a neck, wherein one of the first and second panels is configured to be secured between said planar collar and said planar head, and wherein the other of the first and second panels is configured to be secured about said base. and
angled retaining ledges located between said first outer surface and said second outer surface, said angled retaining ledges being canted in a non-parallel fashion with respect to a plane of at least one of the first and second panels, said angled retaining ledges allowing for safe and easy removal of said base from at least one of the first and second panels, wherein said angled retaining ledges prevent said base from dislodging from at least one of the first and second panels when less than a removal force is applied, and wherein said angled retaining ledges allow said base to be removed from at least one of the first and second panels when the removal force is applied.

19. The fastener assembly of claim 18, wherein said second outer surface is rounded with respect to a longitudinal direction of said second outer surface, and said second outer surface is rounded with respect to lateral directions of said second outer surface over a length of said second outer surface.

20. The fastener assembly of claim 18, wherein said distal tip comprises a central gap that provides increased flexibility to said lateral wings.
